(19) United States
(12) Patent Application Publication
(10) Pub. No.: US 2004/0122805 A1
(43) Pub. Date: Jun. 24, 2004

(54) Apparatus and method for market-based graphical grouping

(76) Inventors: Henry W. Sang JR., Cupertino, CA (US); Scott H. Clearwater, Portola Valley, CA (US)

Correspondence Address: HEWLETT-PACKARD COMPANY, Intellectual Property Administration, P.O. Box 272400, Fort Collins, CO, 80527-2400, US

(21) Appl. No.: 10/326,058

(22) Filed: Dec. 23, 2002

(51) Int. Cl. G06F 7/00

(52) U.S. Cl. 707/3

(57) ABSTRACT

A method and corresponding apparatus for market-based graphical grouping use an automated auction or bartering system, i.e., an automated graphical grouping system, to automatically group graphical and text elements. The automated graphical grouping system enables trading of document elements to generate more valuable and informative groupings for documents. Different characteristics of document elements may be used by the automated graphical grouping system for trading among the document elements. Examples of such tradable characteristics include: physical proximity, type of element (such as text, graphic, or number), style (such as font size), color or the like. The system affords reuse of graphical and text elements in other format in subsequent reflowing documents.

### CROSS-REFERENCE TO RELATED PATENT APPLICATIONS

This application is related to commonly assigned U.S. patent application Ser. No.10/______ (Attorney Docket No. 100202496-1), entitled “APPARATUS AND METHOD FOR MARKET-BASED DOCUMENT CONTENT AND LAYOUT SELECTION” to Scott H. CLEARWATER; U.S. patent application Ser. No.10/______ (Attorney Docket No. 100202497-1), entitled “APPARATUS AND METHOD FOR MARKET-BASED DOCUMENT CONTENT SELECTION” to Scott H. CLEARWATER; U.S. patent application Ser. No.10/______ (Attorney Docket No. 10019008-1), entitled “APPARATUS AND METHOD FOR DOCUMENT CONTENT TRADING” to Scott H. CLEARWATER, et al.; U.S. patent application Ser. No.10/______ (Attorney Docket No. 10018740-1), entitled “APPARATUS AND METHOD FOR CONTENT RISK MANAGEMENT” to Scott H. CLEARWATER, and U.S. patent application Ser. No.10/______ (Attorney Docket No. 10019320-1), entitled “APPARATUS AND METHOD FOR MARKET-BASED DOCUMENT LAYOUT SELECTION” to Henry W. SANG, Jr., et al., all of which are concurrently herewith being filed under separate covers, the subject matters of which are herein incorporated by reference.

### TECHNICAL FIELD

The technical field relates to document management systems, and, in particular, to market-based graphical grouping systems.

### BACKGROUND

Graphical grouping of document elements is important to document composition. However, graphical grouping of document elements is difficult because of lack of semantic data related to the document elements. In addition, a document format, such as portable document format (PDF), typically uses bounding boxes to delimit various elements that are dependent on the process that generates the PDF. Some document formats are not reproducible because the software that generates the document may have evolved over time and the document element grouping may be dependent on which order operations are performed and what steps an author uses to generate document elements. For example, if a title is added after a diagram is laid out, a document may be encoded differently than if the title is added before the diagram. Therefore, being able to automatically group document elements on pages is important to reuse the document elements in other formats in subsequently reflowing documents.

Some current solutions focus on complicated rule sets that are difficult to maintain and understand. For example, since many circumstances cannot be known in advance, a rule-based approach may easily cause error when unanticipated situations occur. Furthermore, while contingencies can in principle be codified, the resulting system is not easily maintainable because the rules can interact with each other in complicated and unforeseen ways.

### SUMMARY

A method for market-based graphical grouping include receiving a plurality of document elements grouped in a current grouping and calculating a value of the current grouping based on relative values of the plurality of document elements. The method further includes consummating a trade among the plurality of document elements to form a new grouping if the value of the new grouping is higher than the value of the current grouping. The new grouping groups together document elements based on relationships of the document elements.

A corresponding apparatus for market-based graphical grouping includes a receiving module capable of receiving a plurality of document elements and a computing module capable of calculating a value of a current grouping based on relative values of the plurality of document elements. The apparatus further includes a trading module capable of consummating a trade among the plurality of document elements to form a new grouping if the value of the new grouping is higher than the value of the current grouping. The new grouping groups together document elements based on relationships of the document elements.

### DESCRIPTION OF THE DRAWINGS

The preferred embodiments of the method and apparatus for market-based graphical grouping will be described in detail with reference to the following figures, in which like numerals refer to like elements, and wherein:

FIG. 1 illustrates an exemplary document with pages that include various objects;

FIG. 2 shows an exemplary automated graphical grouping system, according to one embodiment of the present invention;

FIG. 3 is a flow chart illustrating an exemplary operation of the automated graphical grouping system of FIG. 2, according to another embodiment of the present invention;

FIGS. 4-6 illustrate exemplary methods for using different characteristics of elements to form groups by the automated graphical grouping system of FIG. 2, according to another embodiment of the present invention; and

FIG. 7 illustrates exemplary hardware components that may be used in connection with the method for market-based graphical grouping, according to another embodiment of the present invention.

### DETAILED DESCRIPTION

A method and corresponding apparatus for market-based graphical grouping use an automated auction or bartering system, i.e., an automated graphical grouping system, to automatically group graphical and text elements. The automated graphical grouping system enables trading of document elements to generate more valuable and informative groupings for documents. Different characteristics of document elements may be used by the automated graphical grouping system for trading among the document elements. Examples of such tradeable characteristics include: physical proximity, type of element (such as text, graphic, or number), style (such as font size), color or the like. The system affords reuse of graphical and text elements in other format in subsequent reflowing documents. For example, a document originally produced for a 8½×11 page may later be rendered on a web page or in a portable document format (PDF).

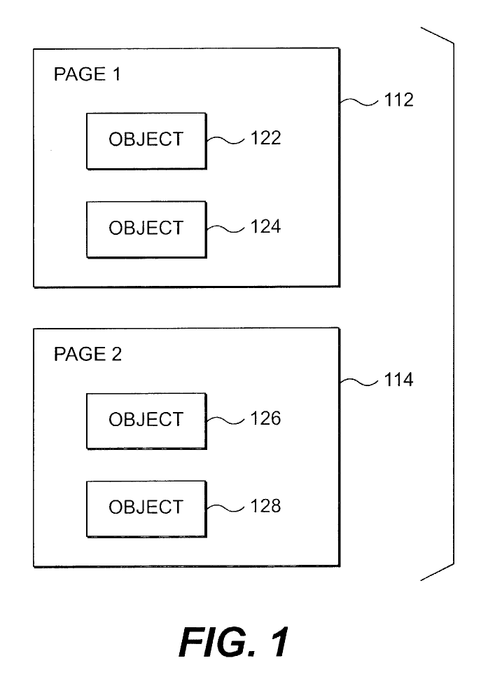

In document construction, different objects are placed on pages. An object refers to any item that can be individually selected and manipulated, and may include shapes and pictures that appear on a display screen. An object may be a self-contained entity that includes both data and programmed procedures that allow manipulation of that data. Examples of the objects include images, tables, columns of information, boxes of data, graphs of data, audio snippets for electronic versions of assignments, active pages such as an applet for electronic version, animations or the like. FIG. 1 illustrates an exemplary document Page 1 112, Page 2 114. Page 1 112 includes objects 122, 124, whereas Page 2 114 includes objects 126, 128.

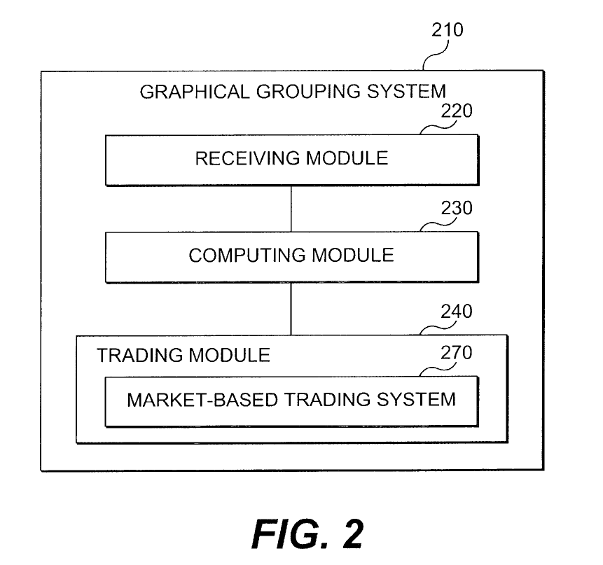

FIG. 2 shows an exemplary automated graphical grouping system 210 that automatically groups graphical and text elements through, for example, an auction process. The automated graphical grouping system 210 includes a receiving module 220 that receives a plurality of document elements, a computing module 230 that calculates a value of a current grouping based on relative values of the plurality of document elements, and a trading module 240 that consummates a trade among the plurality of document elements to form a new grouping with higher value. The trading module 240 may use a market-based trading system 270 to trade document elements. Market-based trading systems 270 have been used in a wide variety of applications to optimize the performance of a computer system or to allocate resources, and may include market-based content selection systems and market-based layout selection systems. The market-based trading systems automatically consummate trades among objects in a documents based on user preferences, efficiently generating high value documents.

With the market-based approach, document elements compete with each other in a “market” where each element both may “buy” other elements to form an association, and may be bought by other elements to join another association of elements. The value of a particular page is based on several factors, such as physical proximity, type of element, style, color or the like. The advantage of a market-based approach is that the market-based approach does not require a fixed set of rules that must be able to handle all possible contingencies.

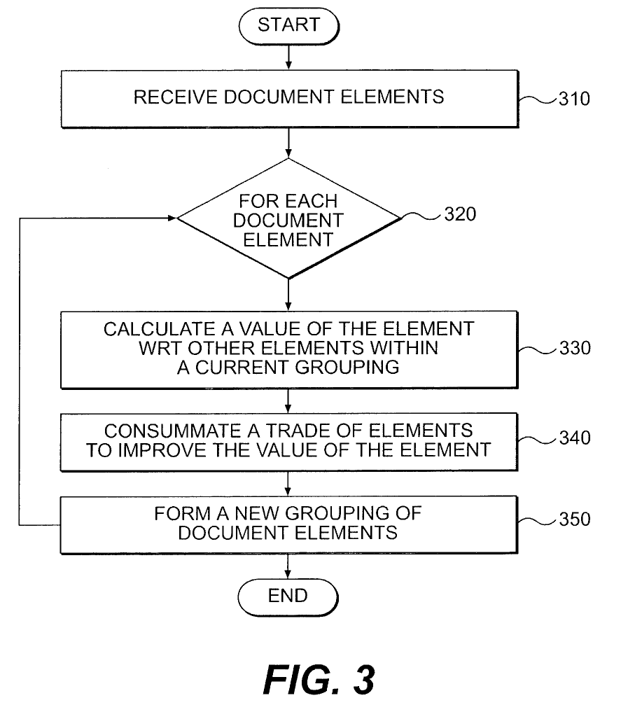

FIG. 3 is a flow chart illustrating an exemplary operation of the automated graphical grouping system 210. The system 210 may enable each document element to act as a bidding agent 240. The bidding agents 240 may trade document elements among one another based on the document elements' value with respect to other related elements. Referring to FIG. 3, the system 210 may receive as input document elements (images and/or text) in a plurality of geometric blocks (block 310). The document elements may be scattered on a page or grouped in a certain fashion. For each element (block 320), the system 210 may calculate a value with respect to other elements within a current grouping (block 330). If the value of element can be improved with a different grouping, the system 210 may consummate one or more trades of the document elements (block 340) to form a new grouping of the elements (block 350). As a result, the input blocks are clustered into more valuable and informative grouping that may be used later, for example, in subsequent reflowing documents.

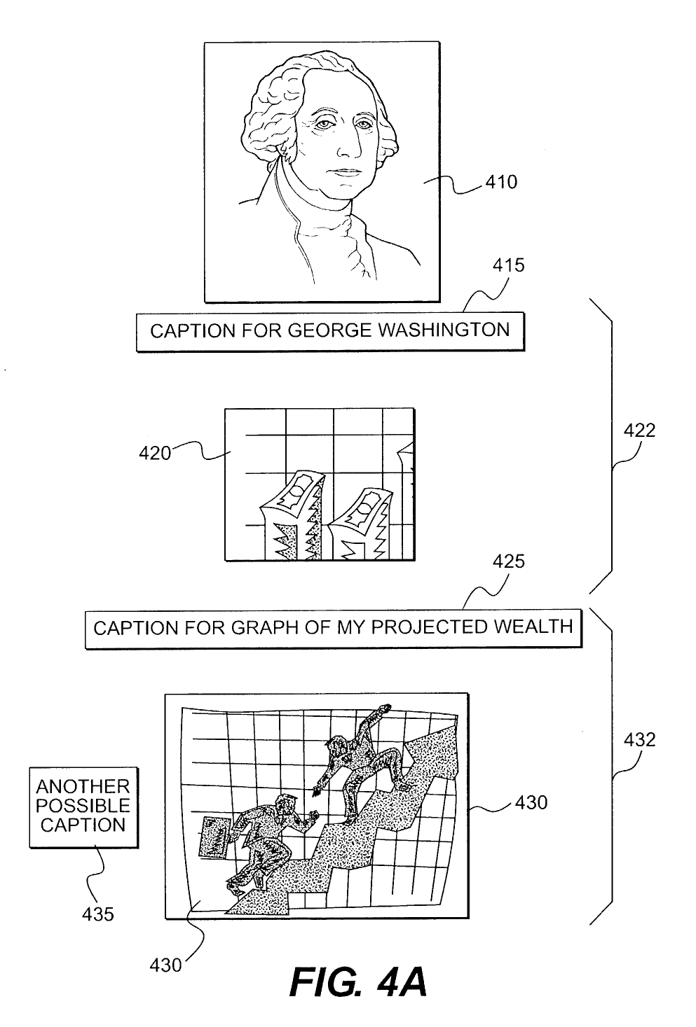

FIGS. 4-6 illustrate exemplary methods for using different characteristics of document elements to form groups. The graphical grouping system 210 may form groups by trading the document elements based on the value assigned to the various elements. physical proximity, type of element (such as text, graphic, or number), style (such as font size), color or the like. For example, an element with some resources available (e.g., space, location, or price tag for sale) may “advertise” the resources to other elements that may value the resources. The original element may respond to the highest bidder and transfer the bartered resource to the highest bidder. The following examples are provided for illustration purposes only. One skilled in the art will appreciate that other types of grouping may be used equally well with the automated graphical grouping system 210.

FIGS. 4A and 4B illustrate an example of graphical grouping of text captions. Referring to FIG. 4A, three graphics 410, 420, 430 and three text captions 415, 425, 435 are presented on a page. Graphic 420 is grouped with caption 425 (grouping 422), whereas graphic 430 is grouped with caption 435 (grouping 432). However, the top graphic 410 is missing a caption, because a grouping algorithm typically matches a graphic with a nearby text element. The grouping algorithm may accomplish the match by, for example, comparing the meta data of the graphic to determine if any of the keywords in the meta data appear in the nearby text elements. The grouping algorithm may then choose the text element with the highest number of matches. Referring to FIG. 4A, with one of the graphics left without a caption, the current grouping is less than desirable, rendering a less valuable document.

To generate a more valuable document, the automated graphical grouping system 210 enables the graphics 410, 420, 430 to trade the captions 415, 425, 435 among one another. For example, the top graphic 410 may be more valuable as a group if the caption below 415 is included. However, the caption below, i.e., the top caption 415, belongs to another graphic, i.e., the middle graphic 420. Therefore, the top graphic 410 may seek to “buy” the top caption 415 from the middle graphic 420. In this example, the middle graphic 420 may sell its caption 415 to the top graphic 410 if the middle graphic 420 can buy another caption, such as the middle caption 425. The bottom graphic 430 may sell its caption 425 to the middle graphic 420 if the bottom graphic 430 can buy another caption, such as the bottom caption 435, without losing value. The bottom caption 435 is unattached in this example and can be acquired by the bottom graphic 430 at a lower price. In this example, associating a caption in close proximity adds value to a graphical element. In addition, a caption can be associated with another graphic element in close proximity.

FIG. 4B illustrates an improved grouping of the graphics and text captions of FIG. 4A. The top graphic 410 is grouped with the top caption 415 (grouping 418), the middle graphic 420 is grouped with the middle caption 425 (grouping 428), and the bottom graphic 430 is grouped with the bottom caption 435 (grouping 438). As a result, the top graphic 410 gained value by associating with the top caption 415, whereas the middle graphic 420 and the bottom graphic 430 are grouped with different captions without losing value.

The system 210 may also interpret and match graphics to keywords or other content analysis of a caption, thus improving the chances that a graphical grouping may be correct. The system 210 may accomplish the match by comparing the meta data of the graphic to determine if any of the keywords in the meta data appear in the nearby text elements. The system 210 may then choose the text element with the highest number of matches.

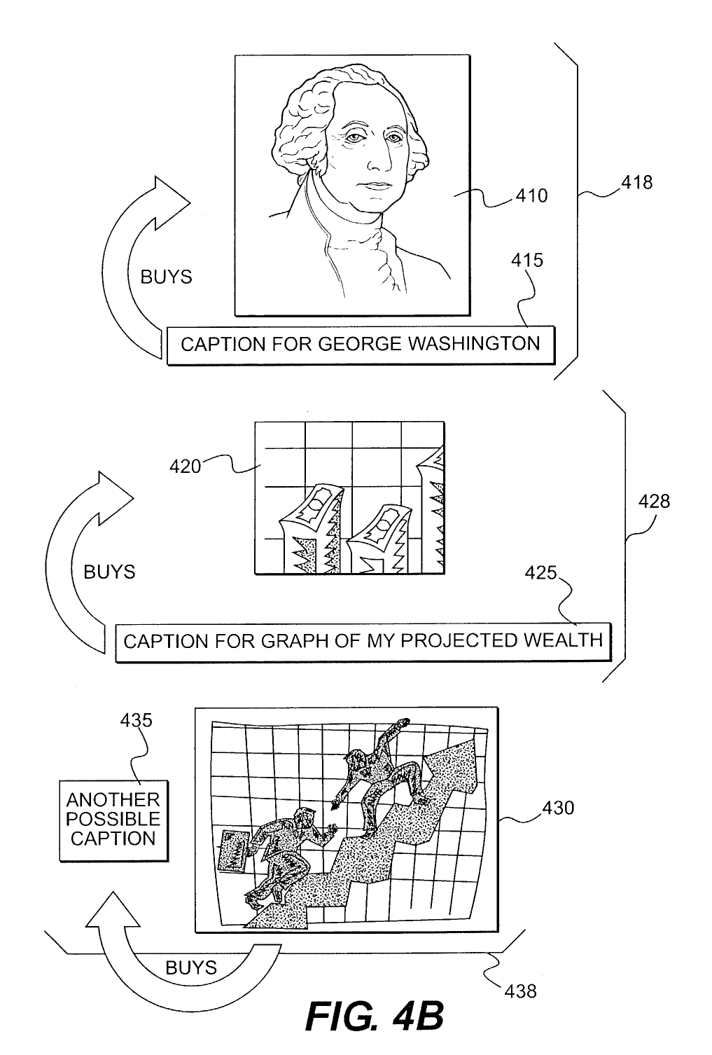

FIG. 5 illustrates an example of graphical grouping for advertising pages with graphics price captions. A graphic may be more valuable if grouped with its associated price. For example, graphics 510, 520, 530, 540, 550, 560, 570, 580 should be associated with price captions 515, 525, 535, 545, 555, 565, 575, 585, respectively. If a mismatch occurs, an agent for a graphic may try to buy the associated price caption object through trading. For example, the 14c price caption 575 may be assigned to a black notebook 580, which is a mismatch because the price caption 575 text does not contain any of the key words or text that are in the meta data associated with the image of the black notebook 580. The 29c price caption 555 may be mistakenly associated with a pad 560. Such initial groupings may lead to unassigned or poorly assigned groupings. For example, the $4.69 price caption 585 may be left alone or possibly associated with a carrying case 510 by mistake, which may in turn leave the $3.99 price caption 515 ungrouped. The automated graphical grouping system 210 may initiate a sequence of trading so that the graphics may be grouped with more valuable price captions, thus forming a more valuable document.

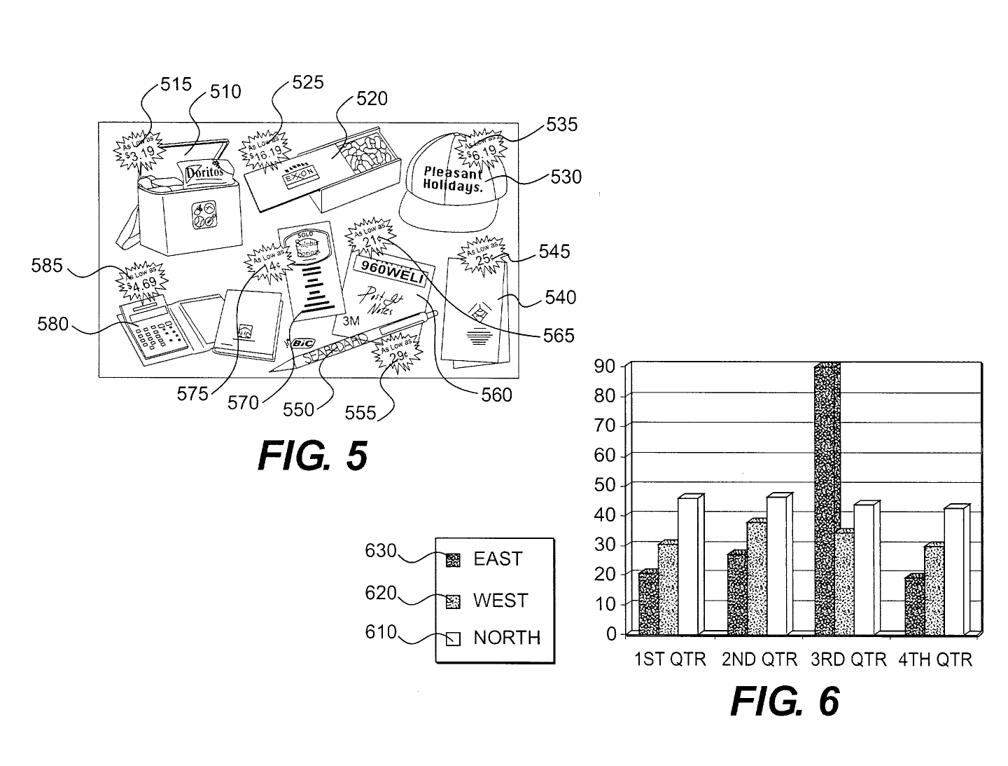

FIG. 6 illustrates an example of graphical grouping of charts or graphs with graphical, textual, numeric elements or the like. For example, the bars need to be grouped with the correct axis labels on the horizontal axis. Each particular bar needs to be grouped with the corresponding entry on a legend. Since physical proximity is not a good indicator for group membership in this example, other data, such as the color of the bar 610, 620, 630 and corresponding entry on the legend, may be used to form a more valuable grouping.

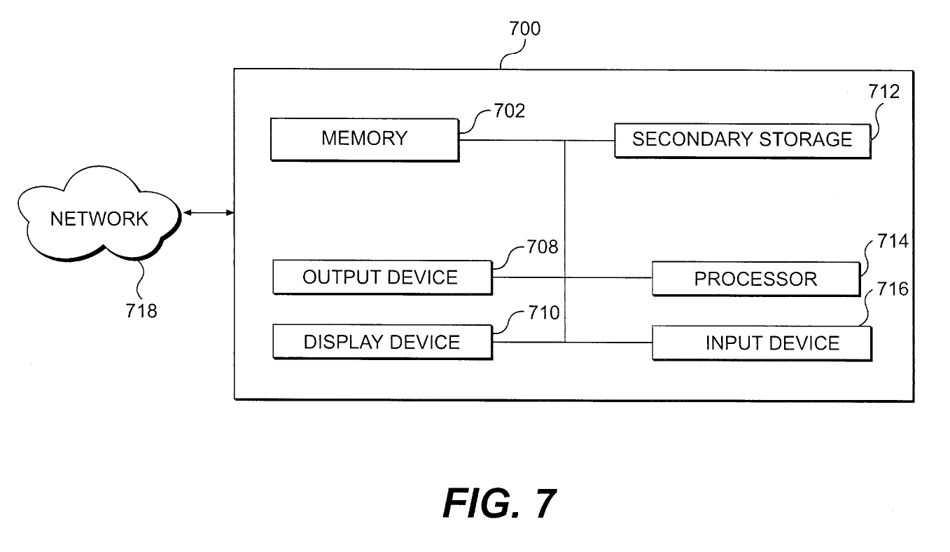

FIG. 7 illustrates exemplary hardware components of a computer 700 that may be used in connection with the method for market-based graphical grouping. The computer 700 includes a connection with a network 718 such as the Internet or other type of computer or telephone network. The computer 700 typically includes a memory 702, a secondary storage device 712, a processor 714, an input device 716, a display device 710, and an output device 708.

The memory 702 may include random access memory (RAM) or similar types of memory. The secondary storage device 712 may include a hard disk drive, floppy disk drive, CD-ROM drive, or other types of non-volatile data storage, and may correspond with various databases or other resources. The processor 714 may execute information stored in the memory 702, the secondary storage 712, or received from the Internet or other network 718. The input device 716 may include any device for entering data into the computer 700, such as a keyboard, keypad, cursor-control device, touch-screen (possibly with a stylus), microphone or the like. The display device 710 may include any type of device for presenting visual image, such as, for example, a computer monitor, flat-screen display, display panel or the like. The output device 708 may include any type of device for presenting data in hard copy format, such as a printer or printing device, and other types of output devices including speakers or any device for providing data in audio form. The computer 700 can possibly include multiple input devices, output devices, and display devices.

Although the computer 700 is depicted with various components, one skilled in the art will appreciate that the computer 700 can contain additional or different components. In addition, although aspects of an implementation consistent with the method for market-based graphical grouping are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the computer 700 to perform a particular method.

While the method and apparatus for market-based graphical grouping have been described in connection with an exemplary embodiment, those skilled in the art will understand that many modifications in light of these teachings are possible, and this application is intended to cover any variations thereof.

What is claimed is:

1. A method for market-based graphical grouping, comprising:
receiving a plurality of document elements, wherein the plurality of document elements are grouped in a current grouping;
calculating a value of the current grouping based on relative values of the plurality of document elements; and
consummating a trade among the plurality of document elements to form a new grouping if the value of the new grouping is higher than the value of the current grouping, wherein the new grouping groups together document elements based on relationships of the document elements.

2. The method of claim 1, wherein the calculating step includes calculating the value of the current grouping based on physical proximities of the document elements.

3. The method of claim 1, wherein the calculating step includes calculating the value of the current grouping based on types of the document elements.

4. The method of claim 1, wherein the calculating step includes calculating the value of the current grouping based on styles of the document elements.

5. The method of claim 1, wherein the calculating step includes calculating the value of the current grouping based on colors of the document elements.

6. The method of claim 1, wherein the consummating step includes consummating the trade to group graphics with associated text captions.

7. The method of claim 1, wherein the consummating step includes consummating the trade to group advertising graphics with associated graphical price captions.

8. The method of claim 1, wherein the consummating step includes consummating the trade to group together document elements in similar colors.

9. The method of claim 1, further comprising using a market-based trading system for the market-based graphical grouping.

10. An apparatus for market-based graphical grouping, comprising:
a receiving module capable of receiving a plurality of document elements, wherein the plurality of document elements are grouped in a current grouping;
a computing module capable of calculating a value of the current grouping based on relative values of the plurality of document elements; and
a trading module capable of consummating a trade among the plurality of document elements to form a new grouping if the value of the new grouping is higher than the value of the current grouping, wherein the new grouping groups together document elements that are associated with one another.

11. The apparatus of claim 10, wherein the trading module uses a market-based trading system for trading among the plurality of document elements.

12. A computer readable medium providing instructions for market-based graphical grouping, the instructions comprising:
receiving a plurality of document elements, wherein the plurality of document elements are grouped in a current grouping;
calculating a value of the current grouping based on relative values of the plurality of document elements; and
consummating a trade among the plurality of document elements to form a new grouping if the value of the new grouping is higher than the value of the current grouping, wherein the new grouping groups together document elements based on relationships of the document elements.

13. The computer readable medium of claim 12, wherein the instructions for calculating include instructions for calculating the value of the current grouping based on physical proximities of the document elements.

14. The computer readable medium of claim 12, wherein the instructions for calculating include instructions for calculating the value of the current grouping based on types of the document elements.

15. The computer readable medium of claim 12, wherein the instructions for calculating include instructions for calculating the value of the current grouping based on styles of the document elements.

16. The computer readable medium of claim 12, wherein the instructions for calculating include instructions for calculating the value of the current grouping based on colors of the document elements.

17. The computer readable medium of claim 12, wherein the instructions for consummating include instructions for consummating the trade to group graphics with associated text captions.

18. The computer readable medium of claim 12, wherein the instructions for consummating include instructions for consummating the trade to group advertising graphics with associated graphical price captions.

19. The computer readable medium of claim 12, wherein the instructions for consummating include instructions for consummating the trade to group together document elements in similar colors.

20. The computer readable medium of claim 12, further comprising instructions for using a market-based trading system for the market-based graphical grouping.

21. An apparatus for market-based graphical grouping, comprising:
means for receiving a plurality of document elements, wherein the plurality of document elements are grouped in a current grouping;
means for calculating a value of the current grouping based on relative values of the plurality of document elements; and
means for consummating a trade among the plurality of document elements to form a new grouping if the value of the new grouping is higher than the value of the current grouping, wherein the new grouping groups together document elements based on relationships of the document elements.

22. The apparatus of claim 21, wherein the means for calculating includes means for calculating the value of the current grouping based on physical proximities of the document elements.

23. The apparatus of claim 21, wherein the means for calculating includes means for calculating the value of the current grouping based on types of the document elements.

24. The apparatus of claim 21, wherein the means for calculating includes means for calculating the value of the current grouping based on styles of the document elements.

25. The apparatus of claim 21, wherein the means for calculating includes means for calculating the value of the current grouping based on colors of the document elements.
